(19) United States
(12) Patent Application Publication
(10) Pub. No.: US 2026/0369491 A1
(43) Pub. Date: Nov. 19, 2026

(54) SCISSOR-TYPE MECHANISM AND SPECIAL-SHAPED KEY STRUCTURE INCLUDING THE SAME

(71) Applicant: Primax Electronics Ltd., Taipei (TW)

(72) Inventors: Chuang-Shu Jhuang, Taipei (TW); Sheng-Huang Huang, Taipei (TW); De-Guang Zhu, Taipei (TW); Rong-Biao Xu, Taipei (TW); Chun-Yuan Liu, Taipei (TW)

(21) Appl. No.: 19/259,879

(22) Filed: Jul. 3, 2025

(30) Foreign Application Priority Data
May 19, 2025 (CN) 202510642525.3

(51) Int. Cl. H01H 13/20; H01H 13/14

(52) U.S. Cl. CPC H01H 13/20; H01H 13/14

(57) ABSTRACT

A scissor-type mechanism includes main, short and long links. The main link has first and second accommodating regions separated from each other, a first engaging end and a first fitting end opposite to each other. The short link is located in the first accommodating region and has a second engaging end and a second fitting end. The long link is located in the second accommodating region and across over a portion of the main link, and has a third engaging end and a third fitting end. An axis of the second engaging end is offset from an axis of the third engaging end, and an axis of the second fitting end is offset from an axis of the third fitting end, and an axis of a middle shaft of the short link is offset from an axis of a middle shaft of the long link.

### FIELD OF THE INVENTION

The present invention relates to a scissor-type mechanism, and more particularly to a scissor-type mechanism including three links (i.e., a main link, a short link, and a long link).

### BACKGROUND OF THE INVENTION

The existing special-shaped key structures (e.g., UK Enter keys) typically include more than two metal stabilizer bars. However, such structures often exhibit poor actuation responsiveness at corners, generate significant noise during pressed, and involve a greater number of components, resulting in higher cost. Therefore, there is a current need for a novel scissor-type mechanism to address the aforementioned technical issues.

### SUMMARY OF THE INVENTION

The present invention provides a scissor-type mechanism is provided, which includes a main link, a short link and a long link. The main link has a first accommodating region and a second accommodating region separated from each other, and a first engaging end and a first fitting end opposite to each other. The short link is located in the first accommodating region of the main link and has a second engaging end and a second fitting end respectively adjacent to the first fitting end and the first engaging end of the main link. The long link is located in the second accommodating region of the main link and across over a portion of the main link, and has a third engaging end and a third fitting end respectively adjacent to the first fitting end and the first engaging end of the main link, in which an axis of the second engaging end is offset from an axis of the third engaging end, and an axis of the second fitting end is offset from an axis of the third fitting end, and an axis of a middle shaft of the short link is offset from an axis of a middle shaft of the long link.

In some embodiments of the present invention, at least one upper protrusion is provided near at least one of the first fitting end of the main link, the second fitting end of the short link, and the third fitting end of the long link.

In some embodiments of the present invention, the at least one upper protrusion is configured to interfere with a keycap.

In some embodiments of the present invention, a lower protrusion is provided near the first engaging end of the main link and is configured to interfere with a membrane circuit board.

In some embodiments of the present invention, a maximum width of the long link is greater than a maximum width of the short link.

In some embodiments of the present invention, a length of an edge of the long link adjacent to the third fitting end is greater than a length of an edge of the short link adjacent to the second fitting end.

In some embodiments of the present invention, the main link has a plurality of the first engaging ends and a plurality of the first fitting ends, and the first engaging ends are located on a first axis, and the first fitting ends are located on a second axis.

The present invention also provides a special-shaped key structure, which includes the aforementioned scissor-type mechanism, a special-shaped keycap, a base plate and a membrane circuit board. The special-shaped keycap is disposed over the scissor-type mechanism. The base plate is disposed beneath the scissor-type mechanism. The membrane circuit board is disposed between the scissor-type mechanism and the base plate.

In some embodiments of the present invention, a lower protrusion is provided near the first engaging end of the main link and is configured to interfere with the membrane circuit board.

In some embodiments of the present invention, the main link of the scissor-type mechanism further has a third accommodating region located between the first accommodating region and the second accommodating region, and is configured to accommodate an elastic member, and the lower protrusion is adjacent to the third accommodating region.

In some embodiments of the present invention, the base plate has a recess substantially aligned with the lower protrusion.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a perspective view of a scissor-type mechanism in an unpressed state according to an embodiment of the present invention.

FIG. 2 is a top view of a special-shaped key structure according to an embodiment of the present invention.

FIG. 3 is an exploded view of a special-shaped key structure shown from one viewing angle according to an embodiment of the present invention.

FIG. 4 is an exploded view of a special-shaped key structure of FIG. 3 shown from another viewing angle.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, the existing special-shaped key structures (e.g., UK Enter keys) typically include more than two metal stabilizer bars. However, such structures often exhibit poor actuation responsiveness at corners, generate significant noise during pressed, and involve a greater number of components, resulting in higher cost. Accordingly, the present invention provides a scissor-type mechanism, which includes a main link, a short link and a long link. Since the scissor-type mechanism includes only three components (i.e., the main link, the short link and the long link), it exhibits high force transmission efficiency, so the scissor-type mechanism provides excellent actuation responsiveness at corners, thereby effectively improving the tactile feel of the special-shaped key structure. In addition, the scissor-type mechanism may further be provided with an upper protrusion that interferes with a keycap and/or a lower protrusion that interferes with a membrane circuit board, thereby achieving a noise-dampening effect, so that the noise generated when the keycap is actuated can be effectively avoided. On the other hand, compared with a conventional scissor-type mechanism that utilizes two metal stabilizer bars and two sets of scissor structures, the scissor-type mechanism of the present invention not only features advantages such as fewer components, higher force transmission efficiency, and simplified assembly, but is also suitable for automated assembly processes, thereby effectively reducing material and manufacturing costs. Various embodiments of the scissor-type mechanism of the present invention and the special-shaped key structure including the same are described in detail below.

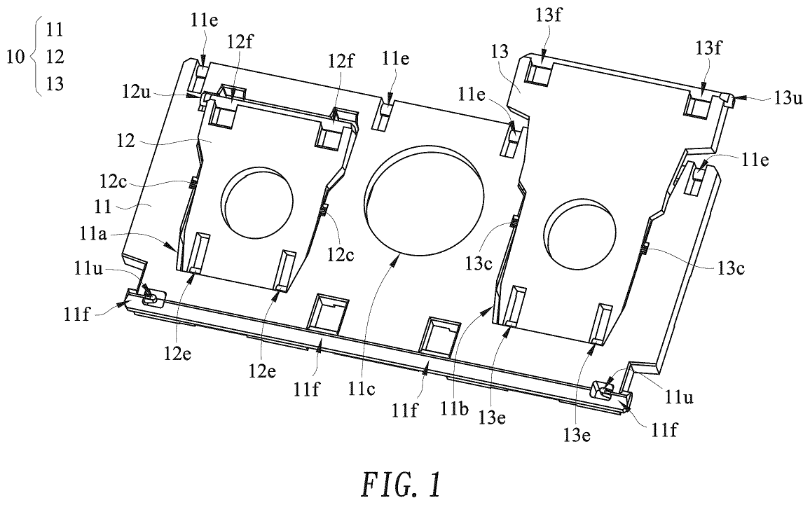

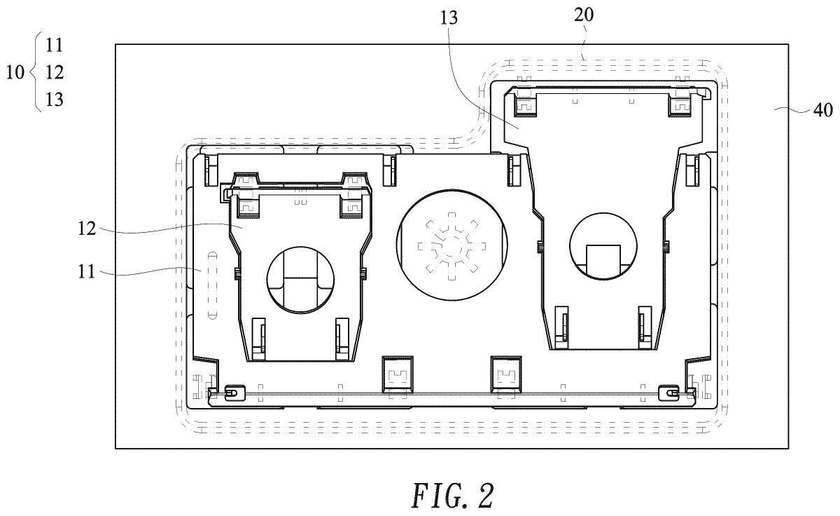

FIG. 1 is a perspective view of a scissor-type mechanism in an unpressed state according to an embodiment of the present invention. FIG. 2 is a top view of a special-shaped key structure according to an embodiment of the present invention. As shown in FIGS. 1 and 2, the scissor-type mechanism 10 includes a main link 11, a short link 12, and a long link 13.

The main link 11 has a first accommodating region 11a and a second accommodating region 11b separated from each other, which are respectively configured to accommodate the short link 12 and the long link 13. In some embodiments, the first accommodating region 11a and the second accommodating region 11b are located on opposite sides of the main link 11.

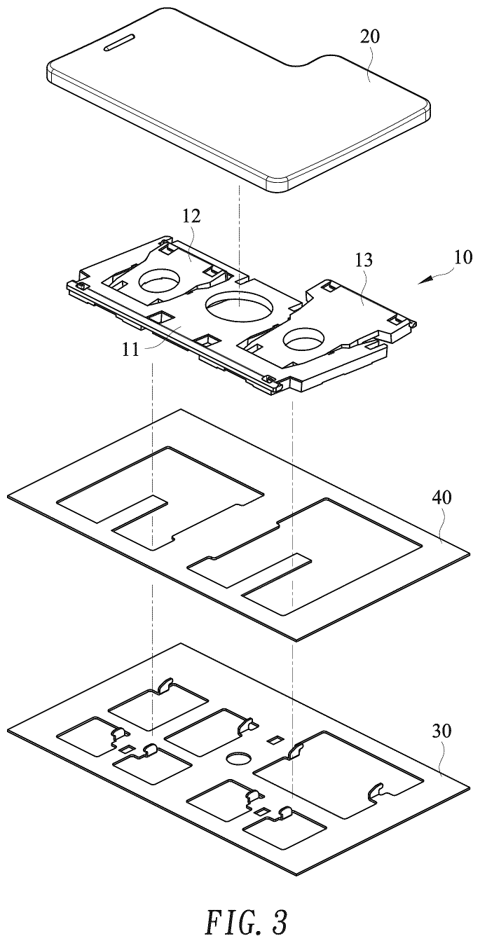

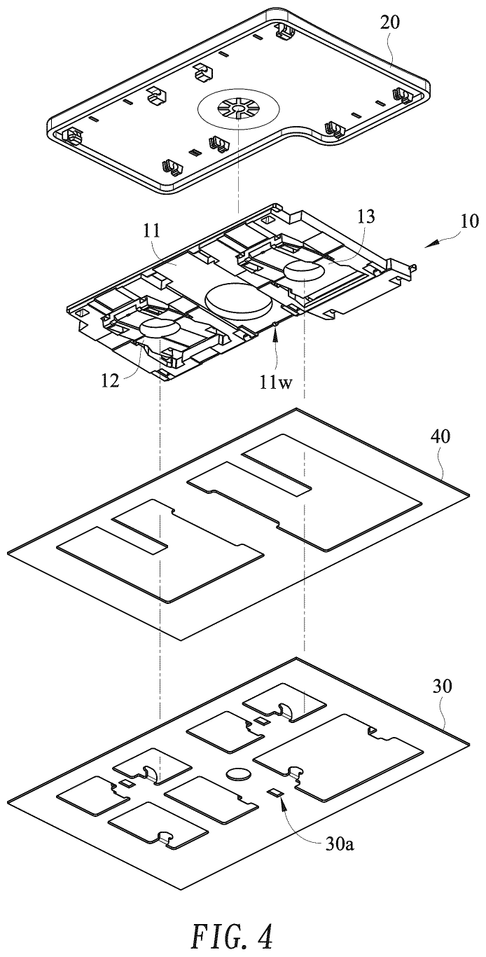

The main link 11 further has a first engaging end 11e and a first fitting end 11f that are opposite to each other. In some embodiments, the first engaging end 11e is configured to cooperate with a hook of a base plate (e.g., a base plate 30 shown in FIG. 3). In some embodiments, the first fitting end 11f is configured to cooperate with a slide groove (refer to FIGS. 2 and 4, not labeled) of a special-shaped keycap 20. In some embodiments, the main link 11 has a plurality of first engaging ends 11e and a plurality of first fitting ends 11f, and the first engaging ends 11e are located on a first axis (not shown), and the first fitting ends 11f are located on a second axis (not shown). The first axis and the second axis are both straight lines.

The short link 12 is located in the first accommodating region 11a of the main link 11, and has a second engaging end 12e and a second fitting end 12f, which are adjacent to the first fitting end 11f and the first engaging end 11e of the main link 11, respectively. In some embodiments, the second engaging end 12e is configured to cooperate with a hook of the base plate (e.g., the base plate 30 shown in FIG. 3). In some embodiments, the second fitting end 12f is configured to cooperate with a snap-fit portion (refer to FIGS. 2 and 4, not labeled) of the special-shaped keycap 20.

The long link 13 is located in the second accommodating region 11b of the main link 11 and across over a portion of the main link 11. The long link 13 has a third engaging end 13e and a third fitting end 13f, which are respectively adjacent to the first fitting end 11f and the first engaging end 11e of the main link 11. In some embodiments, the third engaging end 13e is configured to cooperate with a hook of the base plate (e.g., the base plate 30 shown in FIG. 3). In some embodiments, the third fitting end 13f is configured to cooperate with a snap-fit portion (refer to FIGS. 2 and 4, not labeled) of the special-shaped keycap 20.

In some embodiments, a maximum width of the long link 13 is greater than a maximum width of the short link 12. In some embodiments, a length of an edge of the long link 13 adjacent to the third fitting end 13f is greater than a length of an edge of the short link 12 adjacent to the second fitting end 12f. In some embodiments, a length of an edge of the long link 13 adjacent to the third engaging end 13e is substantially the same as a length of an edge of the short link 12 adjacent to the second engaging end 12e. However, the present invention is not limited to the aforementioned embodiments, and sizes and shapes of the short link 12 and the long link 13 can be appropriately adjusted according to actual needs.

As shown in FIGS. 1 and 2, an axis of the second engaging end 12e is offset from an axis of the third engaging end 13e, and an axis of the second fitting end 12f is offset from an axis of the third fitting end 13f, and an axis of the middle shaft 12c of the short link 12 is offset from an axis of the middle shaft 13c of the long link 13. The term “middle shaft” of the link refers to a swing joint between the link and another link, allowing the two to swing relative to each other.

By means of positional arrangement of axial lines of the first engaging end 11e, the first fitting end 11f of the main link 11, the second engaging end 12e, the second fitting end 12f and the middle shaft 12c of the short link 12, and the third engaging end 13e, the third fitting end 13f and the middle shaft 13c of the long link 13, the main link 11, the short link 12 and the long link 13 are able to transit motion between the special-shaped keycap 20 and the base plate (e.g., the base plate 30 shown in FIG. 3) based on the four-bar linkage mechanism principle.

In addition, since the scissor-type mechanism 10 includes only three components, it exhibits high force transmission efficiency. Therefore, when a corner of the special-shaped keycap 20 is pressed, the applied force can be effectively transmitted to other corners to overcome an elastic force of an elastic member, thereby allowing the special-shaped keycap 20 to move downward. Therefore, the scissor-type mechanism 10 provides excellent actuation responsiveness at corners, which effectively improves the tactile feel of the special-shaped key structure.

From another perspective, the third fitting end 13f of the long link 13 is located outside the main link 11 and positioned beneath a protruding portion of the special-shaped keycap 20, and the engagement between the snap-fit portion (not labeled) of the special-shaped keycap 20 and the third fitting end 13f enhances the corner actuation responsiveness of the protruding portion of the special-shaped keycap 20, thereby effectively improving the tactile feel of the special-shaped key structure.

In some embodiments, at least one upper protrusion is provided near at least one of the first fitting end 11f of the main link 11, the second fitting end 12f of the short link 12, and the third fitting end 13f of the long link 13. As shown in FIG. 1, the first fitting end 11f is provided with upper protrusions 11u at both ends, and the second fitting end 12f is provided with an upper protrusion 12u, and the third fitting end 13f is provided with an upper protrusion 13u. In some embodiments, the at least one upper protrusion (e.g., the upper protrusions 11u, the upper protrusion 12u and the upper protrusion 13u shown in FIG. 1) is configured to interfere with the special-shaped keycap 20. In this manner, noise generated during the actuation of the special-shaped keycap 20 can be effectively avoided.

In some embodiments, a lower protrusion (e.g., a lower protrusion 11w shown in FIG. 4) is provided near the first engaging end 11e of the main link 11, and is configured to interfere with the membrane circuit board (e.g., a membrane circuit board 40 shown in FIG. 4). In this manner, noise generated during the actuation of the special-shaped keycap 20 can be effectively avoided.

FIG. 3 is an exploded view of a special-shaped key structure shown from one viewing angle according to an embodiment of the present invention. FIG. 4 is an exploded view of a special-shaped key structure of FIG. 3 shown from another viewing angle. As shown in FIGS. 2 to 4, the special-shaped key structure includes the above-mentioned scissor-type mechanism 10, the special-shaped keycap 20, the base plate 30 and the membrane circuit board 40. The special-shaped keycap 20 is disposed over the scissor-type mechanism 10. The base plate 30 is disposed beneath the scissor-type mechanism 10. The membrane circuit board 40 is disposed between the scissor-type mechanism 10 and the base plate 30.

In some embodiments, a lower protrusion 11w is provided near the first engaging end 11e of the main link 11 and is configured to interfere with the membrane circuit board 40. In some embodiments, as shown in FIG. 1, the main link 11 of the scissor-type mechanism 10 further has a third accommodating region 11c, which is located between the first accommodating region 11a and the second accommodating region 11b and is configured to accommodate an elastic member (not shown); as shown in FIGS. 1 and 4, the lower protrusion 11w is adjacent to the third accommodating region 11c. In some embodiments, the base plate 30 has a recess 30a substantially aligned with the lower protrusion 11w, so that the membrane circuit board 40 has a deformation space. In some embodiments, the recess 30a is a through hole.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

What is claimed is:

1. A scissor-type mechanism, comprising:
a main link, having a first accommodating region and a second accommodating region separated from each other, and a first engaging end and a first fitting end opposite to each other;
a short link, located in the first accommodating region of the main link, and having a second engaging end and a second fitting end respectively adjacent to the first fitting end and the first engaging end of the main link; and
a long link, located in the second accommodating region of the main link and across over a portion of the main link, and having a third engaging end and a third fitting end respectively adjacent to the first fitting end and the first engaging end of the main link, wherein an axis of the second engaging end is offset from an axis of the third engaging end, and an axis of the second fitting end is offset from an axis of the third fitting end, and an axis of a middle shaft of the short link is offset from an axis of a middle shaft of the long link.

2. The scissor-type mechanism of claim 1, wherein at least one upper protrusion is provided near at least one of the first fitting end of the main link, the second fitting end of the short link, and the third fitting end of the long link.

3. The scissor-type mechanism of claim 2, wherein the at least one upper protrusion is configured to interfere with a keycap.

4. The scissor-type mechanism of claim 1, wherein a lower protrusion is provided near the first engaging end of the main link and is configured to interfere with a membrane circuit board.

5. The scissor-type mechanism of claim 1, wherein a maximum width of the long link is greater than a maximum width of the short link.

6. The scissor-type mechanism of claim 1, wherein a length of an edge of the long link adjacent to the third fitting end is greater than a length of an edge of the short link adjacent to the second fitting end.

7. The scissor-type mechanism of claim 1, wherein the main link has a plurality of the first engaging ends and a plurality of the first fitting ends, and the first engaging ends are located on a first axis, and the first fitting ends are located on a second axis.

8. A special-shaped key structure, comprising:
the scissor-type mechanism of claim 1;
a special-shaped keycap, disposed over the scissor-type mechanism;
a base plate, disposed beneath the scissor-type mechanism; and
a membrane circuit board, disposed between the scissor-type mechanism and the base plate.

9. The special-shaped key structure of claim 8, wherein a lower protrusion is provided near the first engaging end of the main link and is configured to interfere with the membrane circuit board.

10. The special-shaped key structure of claim 9, wherein the main link of the scissor-type mechanism further has a third accommodating region located between the first accommodating region and the second accommodating region, and is configured to accommodate an elastic member, and the lower protrusion is adjacent to the third accommodating region.

11. The special-shaped key structure of claim 9, wherein the base plate has a recess substantially aligned with the lower protrusion.
